(19) United States
(12) Patent Application Publication
(10) Pub. No.: US 2015/0074357 A1
(43) Pub. Date: Mar. 12, 2015

(54) DIRECT SNOOP INTERVENTION

(71) Applicant: QUALCOMM Incorporated, San Diego, CA (US)

(72) Inventors: Joseph G. MCDONALD, Raleigh, NC (US); Jaya Prakash Subramaniam GANASAN, Youngsville, NC (US); Thomas Philip SPEIER, Raleigh, NC (US); Eric F. ROBINSON, Raleigh, NC (US); Jason Lawrence PANAVICH, Pittsboro, NC (US); Thuong Q. TRUONG, Austin, TX (US)

(73) Assignee: QUALCOMM Incorporated, San Diego, CA (US)

(21) Appl. No.: 14/195,792

(22) Filed: Mar. 3, 2014

Related U.S. Application Data
(60) Provisional application No. 61/875,436, filed on Sep. 9, 2013.

(51) Int. Cl. G06F 12/08

(52) U.S. Cl. CPC G06F 12/0831
USPC 711/146

(57) ABSTRACT

A low latency cache intervention mechanism implements a snoop filter to dynamically select an intervener cache for a cache “hit” in a multiprocessor architecture of a computer system. The selection of the intervener is based on variables such as latency, topology, frequency, utilization, load, wear balance, and/or power state of the computer system.

### CLAIM OF PRIORITY UNDER 35 U.S.C. §119

The present Application for Patent claims priority to Provisional Application No. 61/875,436 entitled Direct Snoop Intervention filed Sep. 9, 2013, and assigned to the assignee hereof and hereby expressly incorporated by reference herein.

### FIELD OF DISCLOSURE

Aspects of the present disclosure relate generally to processors, and more particularly, to direct snoop intervention in multiprocessors.

### BACKGROUND

A typical conventional multiprocessor integrated circuit (i.e., chip) utilizes multiple processor cores that are interconnected using an interconnection bus. Each processor core is supported by one or more caches. Each cache stores data files and are typically transferred between a system memory and the caches in blocks of fixed size. The blocks of data are called “cache lines.” Each cache includes a directory of all of the addresses that are associated with the data files it has cached.

Each processor core's cached data can be shared by all other processor cores on the interconnection bus. Thus, it is possible to have many copies of data in the system: one copy in the main memory, which may be on-chip or off-chip, and one copy in each processor core cache. Moreover, each processor core can share the data that is in its cache with any other processor core on the interconnection bus. There is a requirement, therefore, to maintain consistency or coherency with the data that is being shared. The interconnection bus handles all the coherency traffic among the various processor cores and caches to ensure that coherency is maintained.

One mechanism for maintaining coherency in a multiprocessor utilizes what is called “snooping.” When a processor core needs a particular cache line the processor core first looks into its own cache. If the processor core finds the cache line in its own cache, a cache “hit” has occurred. However, if the processor core does not find the cache line in its own cache, a cache “miss” has occurred. When a cache “miss” occurs the other processors' caches are snooped to determine whether any of the other caches have the requested cache line. If the requested data is located in another processor core's cache the other processor core's cache can “intervene” the cache line to provide the cache line to the requesting processor core so that the requesting processor core does not have to access the data from main memory.

This technique of snooping works well if there are only two processor cores and associated caches on the interconnection bus. For example, if the first processor core requests a cache line and the second processor core's cache contains the requested cache line, then the second processor core's cache will provide the requested cache line to the first processor core. If the second processor core's cache does not contain the requested cache line, then the first processor core's cache will access the requested cache line from off-chip main memory. However, as the interconnection bus supports more and more processor cores, any of which may have the requested data in its cache, there needs to be a more complex arbitration mechanism to decide which processor core's cache is to provide the requested cache line to the requesting processor core.

One arbitration mechanism for when there are more than two processor cores and associated caches supported by the interconnection bus includes saving state information in the cache that indicates responsibility for providing data on a snoop request (i.e. saving state information in the “intervener”). When a processor core requests a cache line the interconnection bus “snoops” all connected caches (e.g., by broadcasting the snoop request to all processor caches on the interconnection bus). Each processor core supported by the interconnection bus checks its cache lines and the cache marked as the intervener will provide the requested cache line to the requesting processor core.

More complicated interconnection busses implement a snoop filter, which maintains entries that represent the cache lines that are owned by all the processor core caches on the interconnection bus. Instead of broadcasting the snoop request to all processor caches on the interconnection bus, the snoop filter directs the interconnection bus to snoop only the processor caches that could possibly have a copy of the data.

Historically, the decision-making process for determining the intervening cache is performed based on a fixed scheme. For example, the intervening cache is determined based the last processor core that requested the cache line or the first processor core that requested the cache line. Unfortunately, the first processor core or last processor core may not be the most optimal processor core from which to provide the cache line.

Thus, improved apparatuses and methods for arbitrating an interconnection bus are needed.

### SUMMARY

Example implementations of the invention are directed to apparatuses, methods, systems, and non-transitory machine readable media for directed snoop intervention across a interconnect module bus in a multiprocessor architecture. One or more implementations includes a low latency cache intervention mechanism that implements a snoop filter to dynamically select an intervener cache for a cache “hit” in a multiprocessor architecture.

The mechanism includes an apparatus comprising a snoop module that is configured to obtain a request from a requesting processor to read a requested cache line and to determine that one or more caches associated with one or more owning processors includes the requested cache line. The apparatus further comprises a variables module that is configured to track one or more variables associated with the computer system. The snoop module is further configured to select an owning processor to provide the requested cache line to the requesting processor based on the one or more variables. The apparatus further comprises a signaling module that is configured to signal the selected owning processor to provide the requested cache line to the requesting processor.

The mechanism performs a method comprising obtaining from a requesting processor in a computer system a request to read a requested cache line, determining that one or more caches associated with one or more owning processors includes the requested cache line, selecting an owning processor from among the one or more owning processors to provide the requested cache line to the requesting processor, wherein the selecting the owning processor is based on one or more variables, and informing the selected owning processor to provide the requested cache line to the requesting processor. A non-transitory computer program product may implement this and other methods described herein.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

### BRIEF DESCRIPTION OF THE DRAWINGS

The accompanying drawings are presented to aid in the description of implementations of the technology described herein and are provided solely for illustration of the implementations and not limitation thereof.

FIG. 1 is a block diagram of an example environment suitable for implementing directed snoop intervention across a interconnect module bus in a multiprocessor architecture according to one or more implementations.

FIG. 2 is a block diagram illustrating directed snoop intervention in response to a cache “miss” according to one or more implementations.

FIG. 3 is a block diagram illustrating a computer system according to one or more implementations.

FIG. 4 is an example flow diagram of a methodology for implementing directed snoop intervention across a interconnect module bus in a multiprocessor architecture according to one or more implementations.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

In general, the subject matter disclosed herein is directed to systems, apparatuses, non-transitory computer-readable media, and methods for a low latency cache intervention mechanism in a multiprocessor architecture. In one or more implementations, a interconnect module tracks the location of cache lines in the multiprocessor architecture.

When a processor that is supported by the interconnect module issues a request to read a cache line in one or more other processor core caches, the interconnect module determines which caches contain or own the requested cache line. The interconnect module compares variables that are associated with processor core caches that contain the requested cache line. The interconnect module then selects the cache containing the requested cache line that represents the lowest latency, lowest power, highest speed, etc., as determined by comparing the variables. The selected cache becomes the intervener (i.e., to provide the requested data) for the requesting processor core.

The interconnect module then informs the selected intervener cache to provide the requested cache line to the requesting processor. The selected intervener cache then provides the requested cache line to the requesting processor core. Thus, rather than having a fixed scheme for determining which cache will intervene to provide the requested cache line, the interconnect module dynamically selects an intervening cache based on changing system variables.

It is to be noted that a minimum of one system variable may be considered to determine which cache will be the intervener. Consideration of more than one system variable is not required.

One system variable that may be considered by the interconnect module can include the topology of the multiprocessor architecture. The topology variable can take into consideration whether the cache line is on-chip, whether the cache line is off-chip, whether the cache line is in main memory, whether the cache line is on another multiprocessor chip, etc.

Another system variable that may be considered by the interconnect module may include the power state of the processor core and/or cache. For example, the interconnect module may consider whether the core/cache is in an operating mode or a power saving mode. Modes may include a “sleep” mode, a “power collapse” mode, an “idle” mode, etc.

Another system variable that may be considered by the interconnect module can include the frequency of the processor core and/or the frequency of the cache.

Another system variable that may be considered by the interconnect module can include latency in the heterogeneous system. For example, the interconnect module may support processor cores that have differing architectures, such as one or more Graphic Processing Unit (GPU), one or more digital signal processors (DSP), and/or a mixture of thirty-two bit and sixty-four bit general purpose microprocessor cores. In this scenario, the interconnect module can take into consideration the latency of the individual processor cores or a combination of processor cores.

Another system variable that may be considered by the interconnect module can include the present utilization of the processor core and/or cache. For example, the interconnect module may consider the amount of time that a processor core and/or cache use for processing instructions.

Another system variable that may be considered by the interconnect module can include present utilization of interconnect module segments in the microprocessor architecture, before selecting an owning processor core and/or cache that is to provide the requested cache line.

Another system variable that may be considered by the interconnect module can include wear balancing of processor core and/or cache requests, etc. For example, certain semiconductor technologies (e.g., multi-gate devices such as FinFET) have a characteristic that the failure rate of the circuit is related to how frequently it is “used,” i.e., switched on and off. In one or more implementations, the interconnect module may select a cache to be the intervener based on attempting to distribute work evenly among “equivalent paths” to maximize the life of the semiconductor(s).

Of course, this list of system variables that the interconnect module can consider is not exhaustive, and many more system variables can be considered. For example, the list of system variables can include efficiency factors.

To illustrate, if one processor core's cache is heavily loaded with its own operations and another processor core's cache is idle, although the idle processor core's cache is farther away from the requesting processor core it may be more efficient to obtain the requested cache line from the idle processor core's cache that is farther away from the requesting processor core. Alternatively, if there were two different types of processor cores and one type of processor core includes an inherently longer latency than the other type of processor core, then this variable can be considered by the interconnect module as well. After reading the disclosure herein, it will be apparent how to design more sophisticated or less sophisticated low latency cache intervention mechanisms for a multiprocessor architecture to determine the most efficient intervener choice.

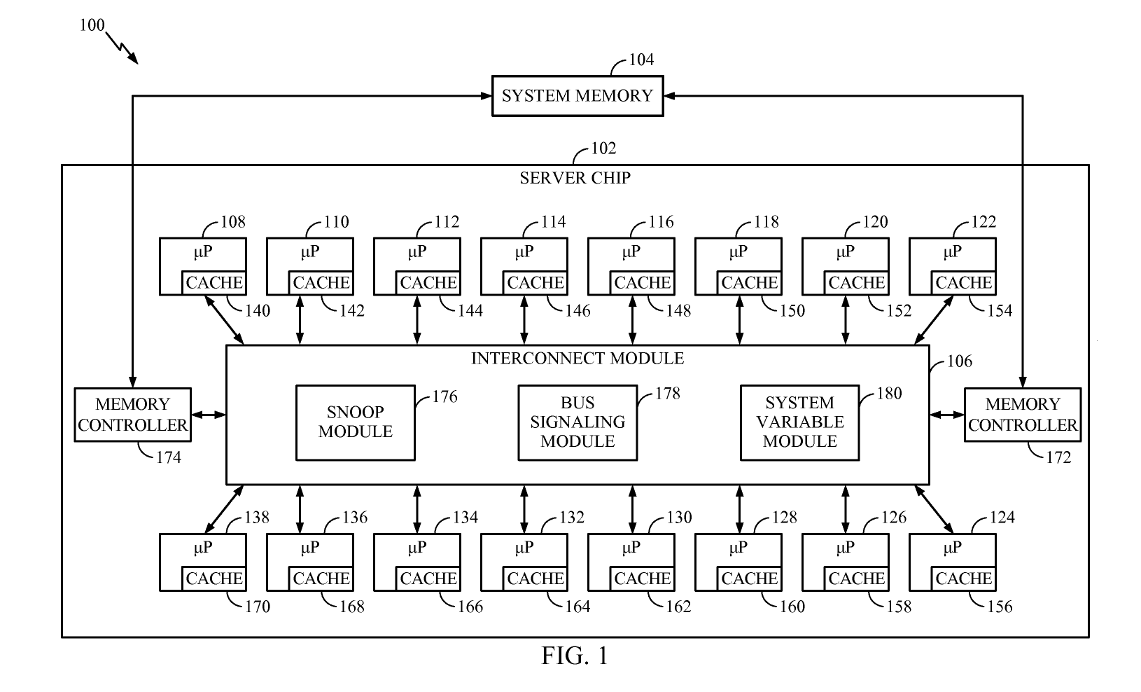

FIG. 1 illustrates a high-level block diagram of an architecture 100 in which an interconnect bus determines an intervener cache that is to provide a requested cache line to a requesting processor core according to one or more implementations described herein. The illustrated architecture 100 includes a chip 102.

Although depicted as a “server” chip, the chip 102 is not so limited. For example, the chip 102 can be any suitable integrated circuit that is capable of supporting multiple processor cores.

The illustrated architecture 100 includes a system memory 104. In one or more implementations, the system memory 104 may include random access memory (RAM), such as dynamic RAM (DRAM), and/or variations thereof. As illustrated, system memory 104 is located external, or off-chip, from the chip 102.

The illustrated architecture 100 includes an interconnect module 106. In one or more implementations, the interconnect module 106 manages data transfers between components in the environment 100.

The illustrated interconnect module 106 supports multiple processor cores, such as processor cores 108, 110, 112, 114, 116, 118, 120, 122, 124, 126, 128, 130, 132, 134, 136, and 138. Each processor core 108, 110, 112, 114, 116, 118, 120, 122, 124, 126, 128, 130, 132, 134, 136, and 138 includes one or more associated caches 140, 142, 144, 146, 148, 150, 152, 154, 156, 158, 160, 162, 164, 166, 168, and 170. The caches are typically small, fast memory devices that store copies of data files that are also stored in system memory 104. The caches also are capable of sharing data files with each other.

The illustrated architecture 100 includes a memory controller 172 and a memory controller 174. The memory controllers 172 and 174 manage the flow of data to and from the system memory 104. In the illustrated implementation, the memory controllers 172 and 174 are integrated on the chip 102. However, the memory controllers 172 and 174 can be separate chips or integrated into one or more other chips.

The illustrated interconnect module 106 includes a snoop module 176. In one or more implementations, the snoop module 176 obtains a request from a requesting processor to read a requested cache line. The snoop module 176 determines whether one or more caches associated with the one or more owning processors include the requested cache line. The snoop module 176 may accomplish this by tracking the location of cache files in the multiprocessor architecture 100 and maintaining entries representing the caches lines stored in each cache. The snoop module 176 may select an owning processor to provide the requested cache line to the requesting processor core based on one or more variables.

The illustrated interconnect module 106 also includes a bus signaling module 178. In one or more implementations, the bus signaling module 178 includes one or more signals that inform a selected processor core's cache to provide a requested cache line to a requesting processor. That is, the bus signaling module 178 signals the selected owning processor core to provide the requested cache line to the requesting processor core.

The illustrated interconnect module 106 also includes a system variable module 180. The illustrated system variable module 180 may track one or more variables associated with a computer system of which the multiprocessor architecture 100 is. The system variable module 180 includes variables that are associated with processor cores and their caches.

The system variables can include the topology of the multiprocessor architecture, such as whether the cache line is on-chip, off-chip (e.g., in system memory, on another multiprocessor chip, etc.).

System variables can include the power state of the processor core and/or cache (e.g., whether the core/cache is in an operating mode or a power saving mode (e.g., “sleep” mode, a “power collapse” mode, an “idle” mode).

Another system variable that may be considered by the interconnect module can include the frequency of the processor core and/or the frequency of the cache.

System variables also include system latency where the computer system is a heterogeneous system. For example, the interconnect module may support processor cores that have differing architectures, such as one or more Graphic Processing Unit (GPU), one or more digital signal processors (DSP), and/or a mixture of thirty-two bit and sixty-four bit general purpose microprocessor cores. In this scenario, the interconnect module can take into consideration the latency of the individual processor cores or a combination of processor cores.

Another system variable that may be considered by the interconnect module can include the present utilization of the processor core and/or cache.

Another system variable that may be considered by the interconnect module can include present utilization of interconnect module segments in the microprocessor architecture before selecting an owning processor core and/or cache that is to provide the requested cache line.

Another system variable that may be considered by the interconnect module can include wear balancing of processor core and/or cache requests, etc. For example, certain semiconductor technologies (e.g., multi-gate devices such as FinFET) have a characteristic that the failure rate of the circuit is related to how frequently it is “used,” i.e., switched on and off. In one or more implementations, the interconnect module may select a cache to be the intervener based on attempting to distribute work evenly among “equivalent paths” to maximize the life of the semiconductor(s).

Of course, this list of system variables is not exhaustive, and the system variable module 180 can include many more system variables.

Each of the caches 140, 142, 144, 146, 148, 150, 152, 154, 156, 158, 160, 162, 164, 166, 168, and 170 includes cache lines. Data files are typically transferred between system memory 104 and the caches in blocks of fixed size. As used herein, the blocks of data are called “cache lines.” Each cache includes a directory of all of the addresses that are associated with the cache lines it has cached.

When a cache line is copied from system memory 104 into a cache, a cache entry is created. The cache entry will include the copied cache line as well as the requested system memory 104 location (typically called a “tag”). When a processor core needs to read or write a location in system memory 104, the processor core first checks for a corresponding entry in the cache. The cache checks for the contents of the requested memory location in any of its cache lines that might contain that address. If the processor core finds that the memory location is in its cache, a cache “hit” has occurred. However, if the processor core does not find the memory location in its cache, a cache “miss” has occurred.

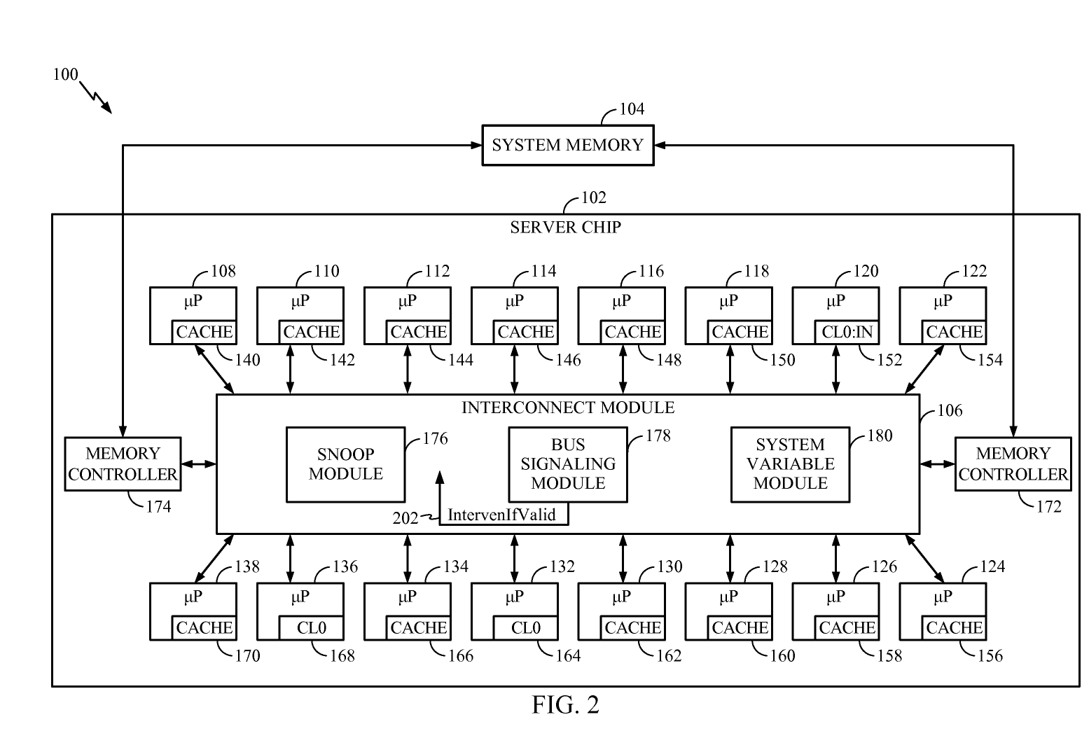

FIG. 2 is a block diagram of illustrating directed snoop intervention in response to a cache “miss” according to one or more implementations. According to one or more implementations of the technology described herein, in the event of a “miss” in a processor core's own cache, the processor core issues a request to read a cache line in a cache associated with one or more other processors.

For purposes of explanation, and with reference to FIG. 2, assume that processor core 134 needs to read cache line 0 in system memory 104 but does not find the memory location in its cache, i.e., a cache “miss” has occurred. Processor core 134 issues a request to read cache line 0 to the interconnect module 106. The snoop module 176 determines that caches 152, 164, and 168 contain the requested cache line, as indicated by the nomenclature “CL0” in the respective caches. The snoop module 176 compares variables contained in the system variable module 180 for the caches 152, 164, and 168. The snoop module 176 then selects the cache containing cache line 0 that represents the lowest latency, lowest power, highest speed, etc. According to the illustrated implementation, the snoop module 176 selects cache 152, as indicated by the nomenclature “CL0:IN.”

The bus signaling module 178 then informs processor core 120 to have its cache 152 provide the cache line 0 to processor core 134. In one or more implementations, the bus signaling module 178 asserts an “IntervenelfValid” signal 202 to inform the processor core 120 to have its cache 152 provide the cache line 0 to processor core 134. In response to the “IntervenelfValid” signal from the bus signaling module 178, the cache 152 then provides cache line 0 to processor core 134.

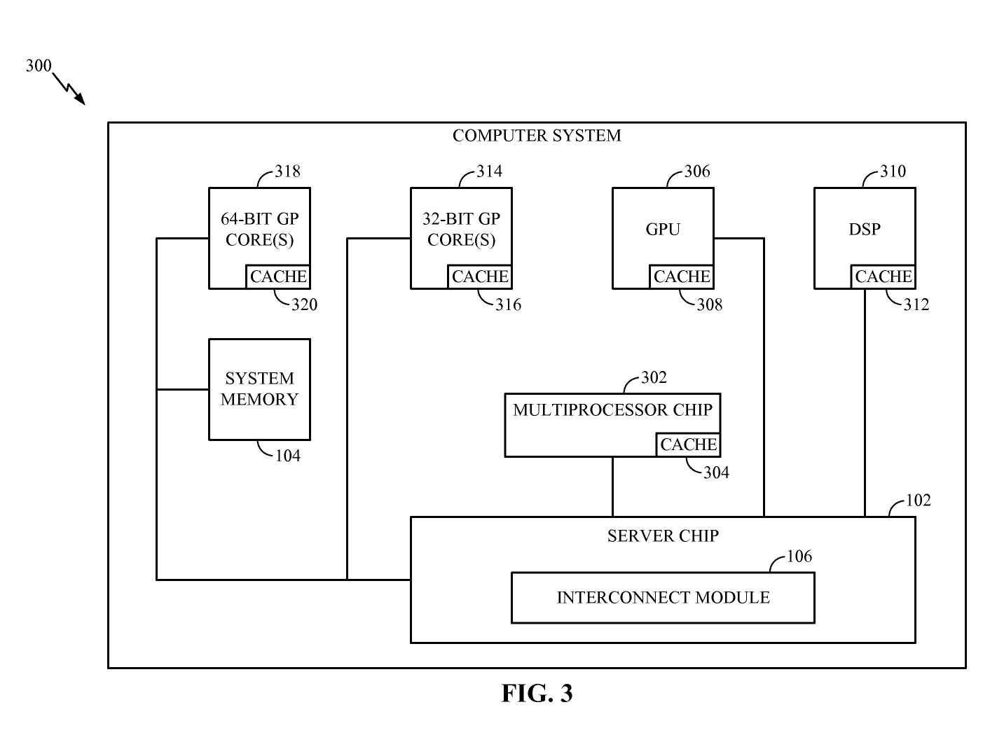

FIG. 3 is a block diagram illustrating a computer system 300 in which directed snoop intervention may be utilized according to one or more implementations. The illustrated computer system 300 includes the server chip 102, system memory 104, and the interconnect module 106 coupled to multiprocessor chip 302 having a cache 304, a Graphics Processing Unit (GPU 306 having a cache 308, a Digital Signal Processor (DSP) 310 having a cache 312, one or more 32-bit general microprocessor cores (32-bit GP core(s)) 314 having one or more caches 316, and one or more 64-bit general microprocessor cores (64-bit GP core(s)) 318 having one or more caches 320.

In one or more implementations, the multiprocessor chip 302 may be any suitable integrated circuit that is capable of supporting multiple processor cores.

In one or more implementations, each of the caches 304, 308, 312, 316, and 320 includes a directory of all of the addresses that are associated with the cache lines it has cached. In one or more implementations, the GPU 306 may be any processing unit that is capable of processing images such as still or video for display. In one or more implementations, the DSP 310 may be any suitable conventional digital signal processor that is capable of performing mathematical operations on data. In one or more implementations, the 32-bit GP core 314 may be any suitable multiprocessor that is capable of operating using a 32-bit instruction set architecture. In one or more implementations, the 64-bit GP core 318 may be any suitable multiprocessor that is capable of operating using a 64-bit instruction set architecture.

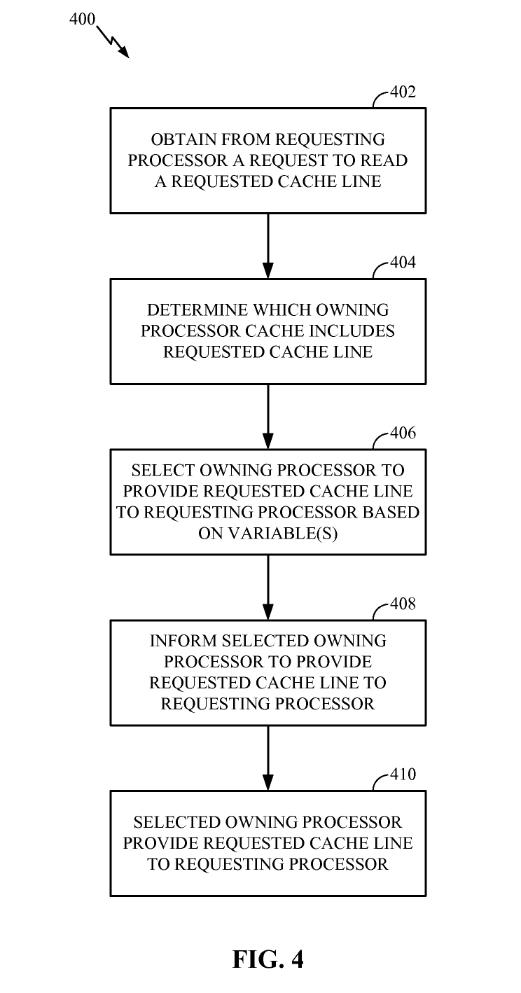

Operation of the computer system 300 is described with reference to FIG. 4, which is an example flow diagram of a method 400 for implementing directed snoop intervention across an interconnect module in a multiprocessor architecture according to one or more implementations. In one or more implementations, a non-transitory computer-readable storage medium may include data that, when accessed by a machine, cause the machine to perform operations comprising the method 400.

In a block 402, the method 400 obtains from a requesting processor a request to read a requested cache line. In one or more implementations, the method 400 obtains a request from a processor core for a cache line after a cache “miss” by the requesting processor core. For purposes of explanation, assume that processor core 134 (illustrated in FIG. 2) issues a request to read cache line 0 to the interconnect module 106.

In a block 404, the method 400 determines which owning processor caches include the requested cache line. In keeping with the example, assume that the snoop module 176 determines that caches 152, 164, and 168 for the processor cores 120, 132, and 136, respectively, contain the requested cache line, as indicated by the nomenclature “CL0” in the respective caches. Thus, the processor cores 120, 132, and 136 own cache line 0 and are therefore considered the “owning” processor cores that have the requested cache line 0.

In a block 406, the method 400 selects an owning processor core to provide the requested cache line to the requesting processor core based on one or more variables in an efficient manner. In one or more implementations, the interconnect module 106 may select an owning processor core to provide the requested cache line to the requesting processor core based on the topology of the computer system 300.

For example, the snoop module 176 may interact with the system variable module 180 to consider whether the requested cache line is on the server chip 102, whether the requested cache line is off-chip, such as in the caches 304, 308, 312, 316, and 320, whether the requested cache line is in system memory 104, and/or whether the requested cache line is on another multiprocessor chip, such as in the cache 304 of the multiprocessor chip 302.

Generally, any time the requested cache line has to cross a chip boundary to get to the requesting processor core it is a much slower process. The interconnect module 106 would take this factor into consideration when selecting the cache that is to be the intervening cache. Accordingly, if the requested cache line were on-chip versus off-chip, the interconnect module 106 may select the owning processor core that is on-chip to provide the cache line even though the last copy of the cache line might be off-chip.

In one or more implementations, the snoop module 176 may interact with the system variable module 180 to determine a power state of an owning processor core and/or cache that is to provide the requested cache line. In keeping with the example, the interconnect module 106 may consider the operating mode or power saving mode of the caches 152, 164, and 168, as well as for the processor cores 120, 132, and 136. For instance, if the processor core 136 is in a lower powered state than the processor core 132 the processor core 136 may not be selected to provide the requested cache line because it may take power and/or time to wake up the processor 136 so that the processor core 136 can provide the requested cache line.

In one or more implementations, the snoop module 176 may interact with the system variable module 180 to determine a frequency of an owning processor core and/or cache that is to provide the requested cache line. In keeping with the example, the interconnect module 106 may consider the frequency of the caches 152, 164, and 168, as well as for the processor cores 120, 132, and 136. For instance, if the processor core 136 is operating at a higher frequency than the processor core 132 it may be more efficient to provide the requested cache line from the processor core 136 and the processor core 132 may not be selected to provide the requested cache line because it may take longer for the processor 132 to provide the requested cache line.

In one or more implementations, the snoop module 176 may interact with the system variable module 180 to determine a latency before selecting an owning processor core and/or cache that is to provide the requested cache line. In keeping with the example, the interconnect module 106 may consider the latency of processor cores 120, 132, and 136. For instance, if the processor core 136 is a different type of processor than the processor core 132, the processor core 132 may have a latency that is inherently longer than the latency of the processor core 136. As such, the processor core 132, even though it may be closer in proximity to the requesting processor core 134 it may be more efficient to provide the requested cache line form the processor core 136 and the processor core 132 may not be selected to provide the requested cache line.

In one or more implementations, the snoop module 176 may interact with the system variable module 180 to determine a load before selecting an owning processor core and/or cache that is to provide the requested cache line. In keeping with the example, if the cache 164 for the processor core 132 is heavily loaded with its own operations and the cache 168 for the processor core 136 is idle, although the cache 168 is farther away from the requesting processor core 120 it may be more efficient to obtain the requested cache line 0 from the cache 168.

In one or more implementations, the snoop module 176 may interact with the system variable module 180 to determine a current utilization of a processor core and/or cache before selecting an owning processor core and/or cache that is to provide the requested cache line. That is, the interconnect module 106 may consider the amount of time that a processor core and/or cache use for processing instructions. In keeping with the example, the interconnect module 106 may consider the effect that the current utilization of processor cores 120, 132, and 136 and/or caches 152, 164, and 168 will have on the latency to intervene the requested cache line.

In one or more implementations, the snoop module 176 may interact with the system variable module 180 to determine a current utilization of interconnect module 106 segments before selecting an owning processor core and/or cache that is to provide the requested cache line. That is, the interconnect module 106 may determine the effect of that the current utilization of processor cores 120, 132, and 136 and/or caches 152, 164, and 168 will have on the latency to intervene the requested cache line.

In one or more implementations, the snoop module 176 may interact with the system variable module 180 to determine a wear balance before selecting an owning processor core and/or cache that is to provide the requested cache line. In keeping with the example, the interconnect module 106 may consider the wear balance of processor cores 120, 132, and 136. For instance, if the processor cores 120, 132, and/or 136 utilize certain semiconductor technologies (e.g., multi-gate devices such as FinFET) that have a characteristic that the failure rate of its circuits is related to how frequently they are “used,” i.e., switched on and off, the interconnect module 106 may select a cache to be the intervener based on attempting to distribute work evenly among “equivalent paths” to maximize the life of the semiconductor(s).

For purposes of explanation, assume that the interconnect module 106 has selected the cache 152 of the processor core 120 as the intervener to provide the requested cache line 0 to the requesting processor 134 because it represents the lowest latency, lowest power, highest speed, etc. The selection is indicated by the nomenclature “CL0:IN” depicted in cache 152.

In a block 408, the method 400 informs the selected owning processor to provide the requested cache line to the requesting processor core. In one or more implementations, the snoop module 176 interacts with the bus signaling module 178 so that the bus signaling module 178 can inform the cache 152 in the processor core 120 to provide cache line 0 to the requesting processor 134. The bus signaling module 178 then informs processor core 120 to have its cache 152 provide the cache line 0 to processor core 134. For example, the bus signaling module 178 may assert the “InterveneIfValid” signal 202 to inform the processor core 120 to have its cache 152 provide cache line 0 to processor core 134.

In a block 410, the selected owning processor provides the requested cache line to the requesting processor. In one or more implementations, in response to the “InterveneIfValid” signal 202 from the bus signaling module 178, the cache 152 for the processor core 120 provides cache line 0 to processor core 134.

Although steps and decisions of various methods may have been described serially in this disclosure, some of these steps and decisions may be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. It should be noted, however, that in selected variants the steps and decisions are performed in the order described above. Furthermore, not every illustrated step and decision may be required in every embodiment/variant in accordance with the invention, while some steps and decisions that have not been specifically illustrated may be desirable or necessary in some embodiments/variants in accordance with the invention.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To show clearly this interchangeability of hardware and software, various illustrative components, blocks, modules, circuits, and steps have been described above generally in terms of their functionality. Whether such functionality is implemented as hardware, software, or combination of hardware and software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an access terminal. Alternatively, the processor and the storage medium may reside as discrete components in an access terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the widest scope consistent with the principles and novel features disclosed herein.

What is claimed is:

1. A method, comprising:
obtaining from a requesting processor in a computer system a request to read a requested cache line;
determining that one or more caches associated with one or more owning processors includes the requested cache line;
selecting an owning processor from among the one or more owning processors to provide the requested cache line to the requesting processor, wherein the selecting the owning processor is based on one or more variables; and
informing the selected owning processor to provide the requested cache line to the requesting processor.

2. The method of claim 1, further comprising maintaining a directory of entries for cache lines associated with the one or more owning processors.

3. The method of claim 1, wherein selecting the cache associated with one owning processor includes comparing a variable associated with one owning processor to a variable associated with at least one other owning processor.

4. The method of claim 3, wherein comparing the variable associated with one owning processor to the variable associated with the at least one other owning processor includes comparing an equivalent variable.

5. The method of claim 1, wherein the one or more variables includes a topology for the computer system.

6. The method of claim 1, wherein the one or more variables includes a power state for the computer system.

7. The method of claim 1, wherein the one or more variables includes a frequency for the computer system.

8. The method of claim 1, wherein the one or more variables includes latency for the computer system.

9. The method of claim 1, wherein the one or more variables includes utilization for the computer system.

10. The method of claim 1, wherein the one or more variables includes a wear balance for the computer system

11. The method of claim 1, wherein the one or more variables includes a load for the computer system.

12. An apparatus for performing cache intervention in a computer system having multiple processors and associated caches, wherein the associated caches include one or more cache lines, comprising:
a snoop module that is configured to:
obtain a request from a requesting processor to read a requested cache line; and
determine that one or more caches associated with one or more owning processors includes the requested cache line;
a variables module that is configured to track one or more variables associated with the computer system, wherein the snoop module is further configured to select an owning processor to provide the requested cache line to the requesting processor based on the one or more variables; and
a signaling module that is configured to signal the selected owning processor to provide the requested cache line to the requesting processor.

13. The apparatus of claim 12, wherein the one or more variables includes a topology for the computer system.

14. The apparatus of claim 12, wherein the one or more variables associated with the multiple processors and associated caches includes a power state for the computer system.

15. The apparatus of claim 12, wherein the one or more variables includes a frequency for the computer system.

16. The apparatus of claim 12, wherein the one or more variables includes latency for the multiprocessor architecture.

17. The apparatus of claim 12, wherein the one or more variables includes utilization for the computer system.

18. The apparatus of claim 12, wherein the one or more variables includes wear balancing for the computer system.

19. The apparatus of claim 12, wherein the one or more variables includes load for the computer system.

20. A non-transitory computer-readable storage medium including data that, when accessed by a machine, cause the machine to perform operations comprising:
obtaining from a requesting processor in a computer system a request to read a requested cache line;
determining that one or more caches associated with one or more owning processors includes the requested cache line;
selecting an owning processor from among the one or more owning processors to provide the requested cache line to the requesting processor, wherein selecting the owning processor is based on one or more variables; and
informing the selected owning processor to provide the requested cache line to the requesting processor.
